(19) United States
(12) Patent Application Publication
(10) Pub. No.: US 2010/0281452 A1
(43) Pub. Date: Nov. 4, 2010

(54) LAYOUT DESIGN METHOD, LAYOUT DESIGN PROGRAM, AND LAYOUT DESIGN APPARATUS

(75) Inventor: Atsushi TOKUMARU, Kanagawa (JP)

Correspondence Address: YOUNG & THOMPSON, 209 Madison Street, Suite 500, Alexandria, VA, 22314, US

(73) Assignee: RENESAS ELECTRONICS CORPORATION, Kanagawa (JP)

(21) Appl. No.: 12/767,186

(22) Filed: Apr. 26, 2010

(30) Foreign Application Priority Data
Apr. 24, 2009 (JP) 2009-106974

(51) Int. Cl. G06F 17/50

(52) U.S. Cl. 716/113

(57) ABSTRACT

It is desired to make it possible to generate a layout whose chip area is small for a semiconductor integrated circuit having a plurality of power supply systems in an internal circuit region. Power supply line of a first power supply is generated in an internal circuit region. Each of primitive cells is generated so that it is connected to the power supply line. It is checked whether or not the timing of a signal supplied to each of the primitive cells from the power supply line of the first power supply satisfies a prescribed criterion. A line for supplying a second potential generated by a second power supply to replace a first potential generated by the first power supply is generated for at least one power supply separation object cell being at least one of the primitive cells after it is checked that the prescribed criterion is satisfied.

### INCORPORATION BY REFERENCE

This application is related to Japanese Patent Application No. 2009-106924 filed at Apr. 24, 2009. The disclosure of that application is incorporated herein by reference.

### BACKGROUND OF THE INVENTION

1. Field of the Invention

The present invention relates to layout design of a semiconductor integrated circuit. In particular, the present invention particularly relates to layout design of a semiconductor integrated circuit having a plurality of power supply systems.

2. Description of Related Art

In a semiconductor integrated circuit, power-supply noises such as fluctuations in the power-supply voltage may occur due to operations of the constituent elements of the semiconductor integrated circuit. The power-supply noises cause jitter, which is a delay variation amount of a signal. In recent years, the semiconductor integrated circuits are increasingly operated at faster speed and with lower voltages, and therefore an increase in jitter has become a problem that cannot be ignored.

Normally, a semiconductor integrated circuit has a plurality of power supply systems that respectively supply powers to an internal circuit region and an input/output buffer circuit region. Further, a semiconductor integrated circuit that has a plurality of power supply systems in an internal circuit region is known. By providing a plurality of power supply systems for the internal circuit region, the power-supply noises can be reduced and, as a result, the increase in jitter can be suppressed.

However, as for layout design of the semiconductor integrated circuit having a plurality of power supply systems in the internal circuit region, it is necessary to ensure a region in which an element can be arranged for each power supply system. Further, under circumstances where higher speeds and lower voltage operations are increasingly promoted, layout design needs to be carried out while taking into account of timing among the power supply lines and the elements. Owing to these factors, an increase in the circuit area is inevitable. Accordingly, in a layout design scheme of the semiconductor integrated circuit having a plurality of power supply systems in an internal circuit region, a technique that realizes power supply separation while suppressing an increase in the area is desired.

FIG. 1 is a flowchart showing a layout design method disclosed in Japanese Patent Publication JP-A-Heisei, 11-297844 (referred to as the Patent Document 1). Referring to FIG. 1, the layout design method includes a step of identifying power supply systems, a step of performing a floor planning for each of the power supply systems, a step of wiring power supply lines for supplying powers to primitive cells, a step of arranging the primitive cells in association with net names of the power supply lines, and a step of wiring among the primitive cells. As mentioned above, a common method can be employed herein for wiring the power supply lines for supplying power to the primitive cells.

The step of wiring the power supply lines for supplying power to the primitive cells (Step A5 in FIG. 1) is carried out between the floor planning step and the primitive cell arranging step. In the primitive cell arranging step, a region where the wiring name given to each power supply line and power supply information owned by each primitive cell agree with each other is searched for, and the corresponding cell is arranged therein (Steps A6 to A9 in FIG. 1). By carrying out the arrangement in this manner, the power supply separation is realized.

In the following, referring to the flowchart of FIG. 1, the operation of an exemplary technique is described in detail, in which a common technique is applied to a circuit having two power supplies VDD1 and VDD2. First, in the semiconductor integrated circuit structured with a plurality of power supplies, circuits are classified by power supply system into VDD1 system circuits and VDD2 system circuits, as shown in FIG. 3 (Step A1 in FIG. 1).

Next, in Step A4 in FIG. 1, arrangement regions are specified for respective power supply systems classified in Step A1. As shown in FIG. 5, the arrangement regions are specified such that different arrangement regions overlap with each other, in order to increase the degree of flexibility in wiring the power supply lines (Step A5) described later. In the exemplary case shown in FIG. 5, primitive cells 121 and 122 shown in FIG. 4 are arranged in one power supply system related arrangement region 123. The other power supply system related arrangement region 124 and the arrangement region 123 partially overlap with each other.

Next, wiring of the power supply lines is carried out (Step A5). As shown in FIG. 2, wiring of power supply lines 107 and 108 for supplying power to power supply terminals 103 and 104 of the primitive cell 101, and to power supply terminals 105 and 106 of the primitive cell 102, is carried out. The wiring of the power supply lines is carried out based on the floor plan specified in Step A4. As shown in FIG. 6, the power supply lines are separated using longitudinal paths and the like.

Next, the primitive cell arranging step is described. A region where the wiring name given to each power supply line wired in Step A5 and the power supply information owned by each primitive cell agree with each other is searched for based on circuit connection information, and the arrangement region for the primitive cell is determined (Steps A6 to A9 in FIG. 1).

The arranging step is described in an exemplary case where the power supply terminal of a primitive cell is used as the power supply information of the primitive cell. As shown in FIG. 6, when a primitive cell 134 having a VDD1 terminal 135 and a GND terminal 136 is to be arranged, based on circuit information, a region where the terminal name of each power supply terminal of the primitive cell 134 and the line name of the power supply line wired in Step A5 agree with each other is searched for (Step A6 in FIG. 1).

Next, in Step A7 in FIG. 1, as to the arrangement position of the primitive cell determined by the searching, whether or not the power supply line name and the power supply terminal name of the primitive cell agree with each other is checked. As a result of the checking, when a VDD1 power supply terminal 142 of a primitive cell 141 is arranged on a VDD2 power supply line 144 as shown in FIG. 7, the arrangement position of the primitive cell 141 is searched for again (the operation returns to Step A6).

When power supply terminals 152 and 153 of a primitive cell 151 are respectively arranged on power supply lines 156 and 155, and thus they agree with each other in power system as shown in FIG. 8, the arrangement position is determined (Step A8 in FIG. 1), and the next step is executed. In the next Step A9, whether or not there are any yet-to-be arranged cells is checked. Until there are no yet-to-be arranged cells left, Steps A6 to A9 are repeatedly executed. After the arrangement of every cell is completed, wiring is planned as schematic wiring, based on the circuit connection information (Step A10 in FIG. 1).

In Step A11 in FIG. 1, whether or not wiring is possible according to the result of the schematic wiring (Step A10) is determined. Here, when it is determined that the wiring is impossible, the operation returns to different steps depending on the following conditions. As a first condition, if the wiring is demanding for an entire chip, and therefore the chip size must be fundamentally reconsidered, the operation returns to Step A2, and the chip size is adjusted. As a second condition, as shown in FIG. 9, if the wiring is demanding for a region 161 where the power supply separation has been carried out or for the surrounding region thereof, and therefore a reconsideration such as expansion of the region is necessary, the operation returns to Step A5 in FIG. 1, and the wiring of corresponding power supply line is adjusted. FIG. 10 shows an exemplary case as a result of adjusting the wiring of the power supply line VDD2 shown in FIG. 9 and arranging the primitive cells. It is to be noted that, in Step A11 in FIG. 1, when it is determined that the wiring is possible, final detailed wiring is carried out, and the layout is completed. According to the method described above, the power supply separation of the semiconductor integrated circuit structured with a plurality of power supplies is realized.

Japanese Patent Document JP2006-278404A (referred to as the Patent Document 2) discloses one example of a method of power supply separation layout design. Being different from the power supply separation within an identical wiring layer as described above, the Patent Document 2 discloses a technique for carrying out power supply separation in a semiconductor integrated circuit having power supply wiring layers as many as the number of power supply systems.

### SUMMARY OF THE INVENTION

According to the technique described in the Patent Document 1, the primitive cell arrangement area is specified in Step A4, which is the floor planning Step in FIG. 1. Therefore, in a case where the power supply separation is carried out in a semiconductor integrated circuit having a plurality of power supply systems in an internal circuit region, it is necessary to ensure a primitive cell arrangement region for each power supply system in the floor planning step. In such a layout design method, a margin of the arrangement region is necessary in addition to the arrangement region required for the functionality of the circuit. Therefore, it poses a problem that the arrangement region becomes greater. The mechanism of occurrence of the problem will be described in the following, referring to FIGS. 11 and 12.

FIG. 11 is a schematic diagram of layout design in which power supply separation is performed in a semiconductor integrated circuit having two power supply systems, namely a first potential and a second potential, in an internal circuit. As shown therein as an exemplary case, a clock is distributed from a clock supply block 165 to memory interface control blocks 163 and 164, and a signal from the outside of the chip is inputted from a signal input terminal 166 to RAM 176 arranged in a chip arrangement region 167.

In FIG. 11, the chip arrangement region 167 is supplied with the first potential generated by a first power supply that is a main power supply of the chip. To the memory interface control blocks 163 and 164 and the clock supply block 165, a second power supply that generates the second potential is connected as a dedicated power supply. The power supply separation has been carried out between a primitive cell region 162 and the chip arrangement region 167. Relay primitive cells 168, 169 and 170 in consideration of waveform rounding when a clock is distributed from the clock supply block 165 to the memory interface control blocks 163 and 164 are arranged in the primitive cell region 162, and therefore the primitive cell region 162 is supplied with the second potential. At the timing where the external signal from the signal input terminal 166 is inputted to the RAM 176, the RAM 176 is supplied with the first potential. Therefore, relay primitive cells 171, 172, and 173 in consideration of waveform rounding are arranged in the chip arrangement region 167.

FIG. 12 is an enlarged view showing details of the power supply separation in the primitive cell region 162 shown in the schematic diagram of FIG. 11. The power supply separation has been carried out between the primitive cell region 162 that is supplied with the second potential and the chip arrangement region 167 that is supplied with the first potential.

To the primitive cell arrangement region 162, the second potential is supplied from a power supply line in which an upper layer power supply line 175a and a lower layer power supply line 175b of the second potential are wired in a grid formation. To the chip arrangement region 167, the first potential is supplied from a power supply line in which an upper layer power supply line 174a and a lower layer power supply line 174b of the first potential are wired in a grid formation. In the primitive cell arrangement region 162, the primitive cells 168, 169, and 170 of the second potential are arranged. In the chip arrangement region 167, the primitive cells 171, 172, and 173 of the first potential are arranged.

With this technique, the chip arrangement region 167 in which the primitive cells 171, 172, and 173 of the first potential can be arranged and the primitive cell region 162 in which the primitive cells 168, 169, and 170 of the second potential can be arranged as shown in FIG. 3 are determined in Step A4 of the floor planning Step in FIG. 1. In Step A5 of the power supply/GND wiring step, power supply wiring of the power supply lines 174a and 174b of the first potential and the power supply lines 175a and 175b of the second potential are respectively carried out for the primitive cell region 162 and the chip arrangement region 167.

Meanwhile, in some cases, after the detailed wiring step, an additional primitive cell is provided or the primitive cell size is changed, in order to modify the circuit or adjust the timing. When determining the arrangement of the primitive cell region 162 in the floor planning step, the primitive cell region 162 needs to be ensured to have a margin for carrying out such an addition or a change.

The reason therefor is as follows. If an addition or a change in size of the primitive cell is required due to the circuit modification or the timing adjustment after the detailed wiring Step A12 in FIG. 1, then, as a result, there is a possibility that the primitive cell region 162 cannot accommodate the additional primitive cell or the primitive cell changed in size. In such a situation, the operation returns to Step A4 of the floor planning step, and the design needs to be re-produced.

At the stage of the floor planning step, it is uncertain whether or not necessity of an addition or a change in size of the primitive cell arises after the detailed wiring step. However, in order to avoid re-production of the design, it is necessary to predict an addition or a modification in size of the primitive cell, and to ensure the primitive cell arrangement region with a margin therefor, at the stage of the floor planning step. For example, as shown in FIG. 12, the primitive cell arrangement region 162 must be ensured based on the prediction that approximately how many primitive cells are to be added except for the primitive cells 168, 169, and 170. Hence, such a layout design method poses a problem of an increase in the area of the primitive cell arrangement region which undergoes the power supply separation.

According to an aspect of the present invention, a layout design method includes: generating a power supply line of a first power supply in a layout of an internal circuit region; generating an arrangement of each of a plurality of primitive cells to connect to the power supply line; checking whether or not a timing of a signal supplied to each of the plurality of primitive cells from the power supply line of the first power supply satisfies a prescribed criterion; and generating a line for supplying a second potential generated by a second power supply to replace a first potential generated by the first power supply for at least one power supply separation object cell being at least one of the plurality of primitive cells after it is checked that the prescribed criterion is satisfied.

According to another aspect of the present invention, a layout design program makes a computer perform each of the operations included in the layout design method according to the present invention.

According to further another aspect of the present invention, a layout design apparatus includes: a single power supply wiring section configured to generate a power supply line of a first power supply in a layout of an internal circuit region; a primitive cell generation section configured to generate an arrangement of each of a plurality of primitive cells to connect to the power supply line; a timing check section configured to check whether or not a timing of a signal supplied to each of the plurality of primitive cells from the power supply line of the first power supply satisfies a prescribed criterion; and a potential changeover section configured to generate generating a line for supplying a second potential generated by a second power supply to replace a first potential generated by the first power supply for at least one power supply separation object cell being at least one of the plurality of primitive cells after it is checked that the prescribed criterion is satisfied.

According to the present invention, it becomes possible to produce a layout being small in a chip area regarding a semiconductor integrated circuit having a plurality of power supply systems in an internal circuit region.

### BRIEF DESCRIPTION OF THE DRAWINGS

The above and other objects, advantages and features of the present invention will be more apparent from the following description of certain preferred exemplary embodiments taken in conjunction with the accompanying drawings, in which:

FIG. 1 is a flowchart of a layout design method of a background art;

FIG. 2 is a layout chart for describing a background art;

FIG. 3 is a layout chart for describing a background art;

FIG. 4 is a layout chart for describing a background art;

FIG. 5 is a layout chart for describing a background art;

FIG. 6 is a layout chart for describing a background art;

FIG. 7 is a layout chart for describing a background art;

FIG. 8 is a layout chart for describing a background art;

FIG. 9 is a layout chart for describing a background art;

FIG. 10 is a layout chart for describing a background art;

FIG. 11 is a layout chart for describing a background art;

FIG. 12 is a layout chart for describing a background art;

FIG. 13 is a flowchart of a layout design scheme of a semiconductor integrated circuit according to an embodiment;

FIG. 14 is a layout chart for describing an embodiment of the present invention;

FIG. 15 is a layout chart for describing an embodiment of the present invention;

FIG. 16 is a system configuration diagram for carrying out an embodiment of the present invention;

FIG. 17 is a layout chart for describing an embodiment of the present invention;

FIG. 18 is a layout chart for describing an embodiment of the present invention;

FIG. 19 is a layout chart for describing an embodiment of the present invention;

FIG. 20 is a detailed flowchart of a potential changeover step in an embodiment of the present invention;

FIG. 21 is a layout chart for describing an embodiment of the present invention; and

FIG. 22 is a block diagram of a layout design apparatus in an embodiment of the present invention.

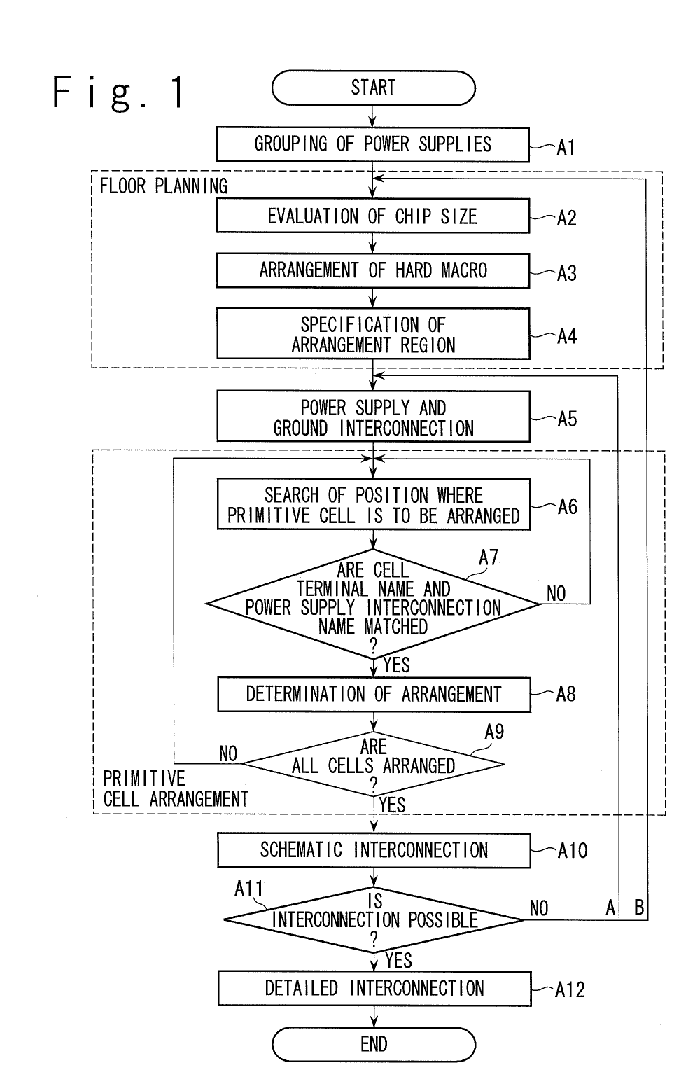

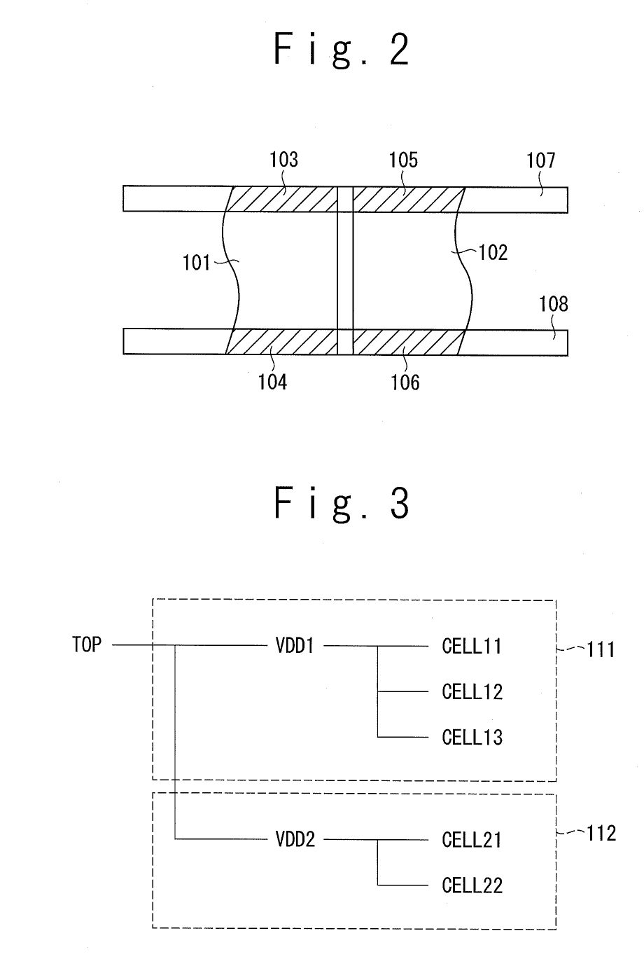

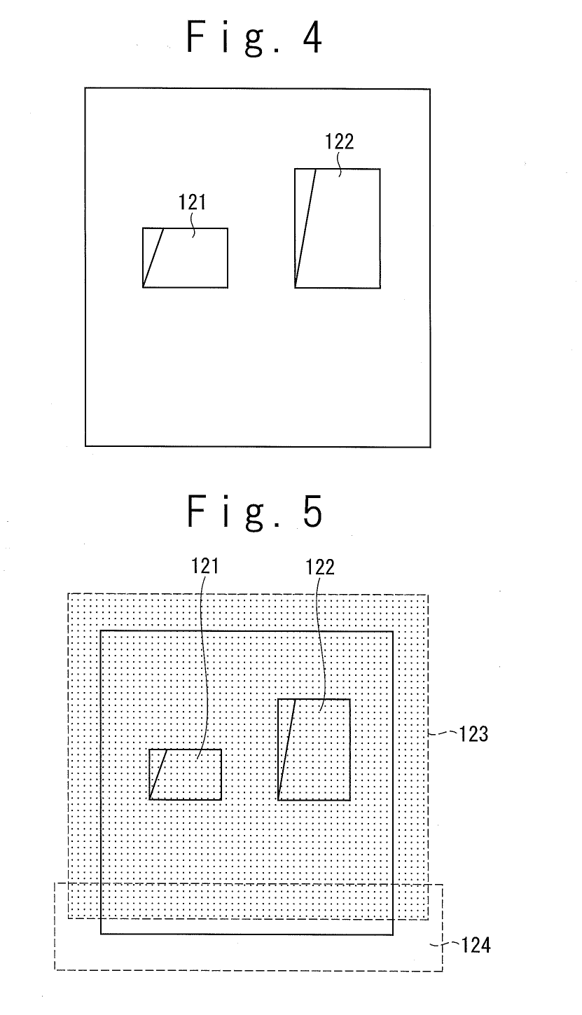

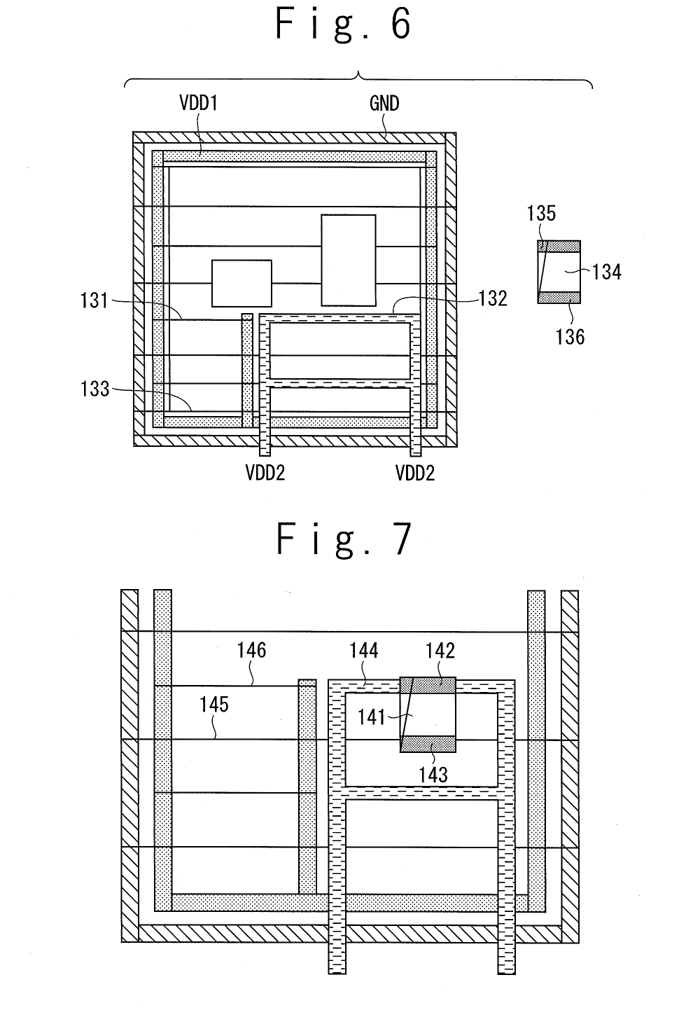

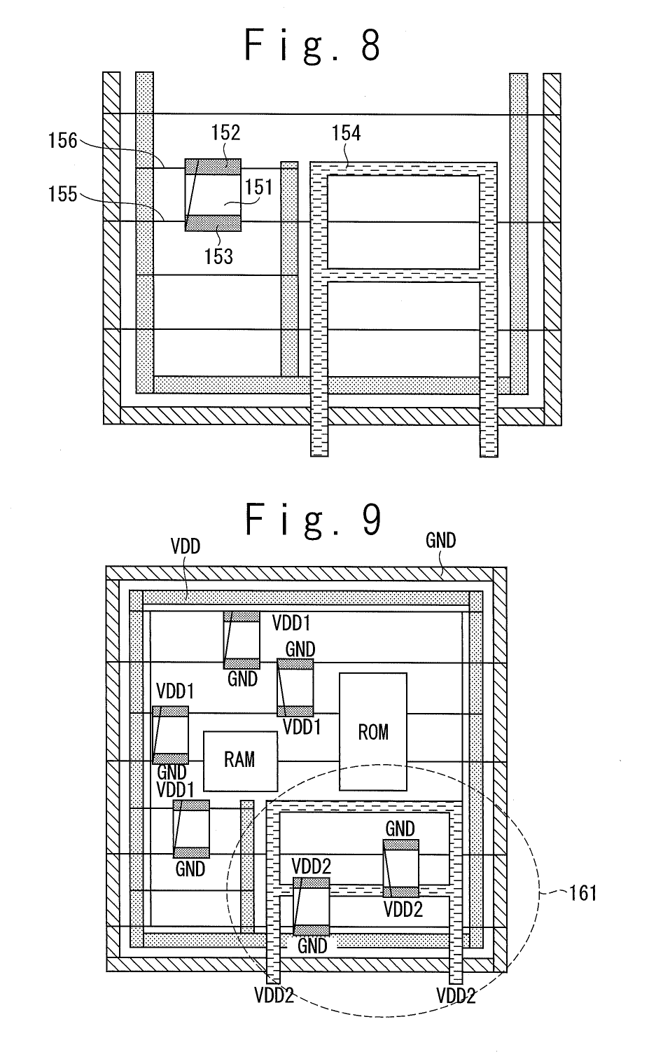

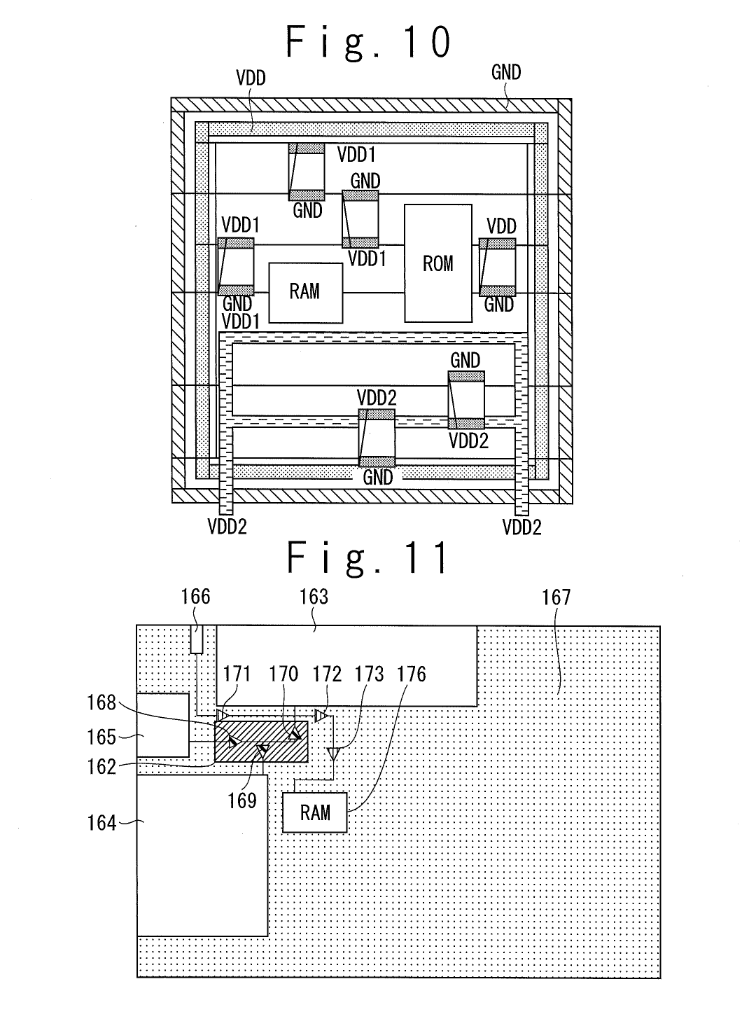

### DESCRIPTION OF THE PREFERRED EMBODIMENTS

Referring to FIG. 16, an embodiment of the present invention will be described. FIG. 16 is a system configuration diagram for carrying out a layout design method according to the present embodiment. The system is structured with a computer apparatus 16, a server 17, and a network 19. The server 17 is provided with a storage medium 18. The storage medium 18 stores an execution program for causing the computer to execute the layout design method. The server 17 is connected to the computer apparatus 16 such as an engineering workstation via the network 19 such as the Internet. The execution program stored in the storage medium 18 is downloaded via the network 19 to the computer apparatus 16. The downloaded program is stored in a local hard disk, memory, or the like of the computer apparatus 16, and is executed by the computer apparatus 16.

The operations of the present embodiment will be described referring to FIGS. 13, 14 and 15. FIG. 13 is a flowchart of a layout design method of a semiconductor integrated circuit according to the present embodiment. It shows a procedure of carrying out power supply separation in a semiconductor integrated circuit having a plurality of power supply systems in an internal circuit.

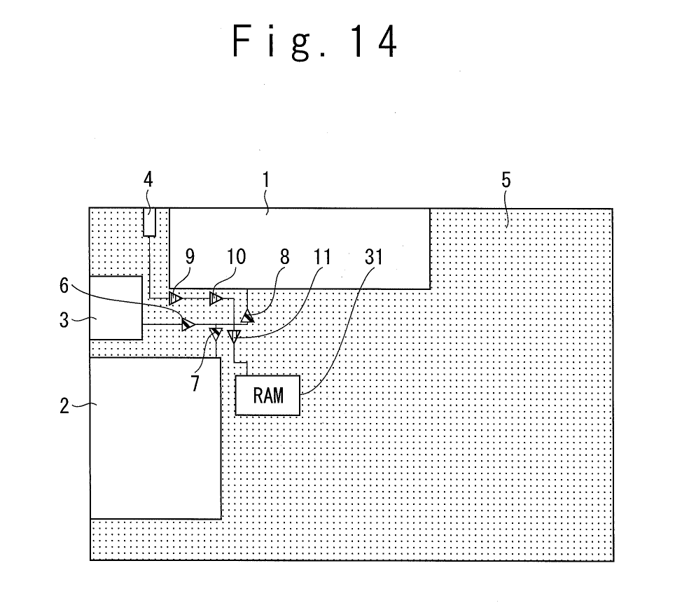

FIG. 14 is a schematic diagram of layout design in which power supply separation is carried out according to the flowchart of FIG. 13 of the present embodiment in a semiconductor integrated circuit that has two power supply systems, namely a first potential and a second potential, in an internal circuit. In this exemplary case, a clock signal is distributed from a clock supply block 3 to memory interface control blocks 1 and 2, and a signal from outside of the chip is inputted via a signal input terminal 4 to RAM 31 arranged in a chip arrangement region 5.

In FIG. 14, the chip arrangement region 5 is supplied with the first potential that is a main power supply of the chip. The memory interface control blocks 1 and 2 and the clock supply block 3 are supplied with the second potential as a dedicated power supply. In consideration of waveform rounding when a clock is distributed from the clock supply block 3 to the memory interface control blocks 1 and 2, relay primitive cells 6, 7 and 8 are arranged in the chip arrangement region 5. Being separated from the main power supply, the primitive cells 6, 7 and 8 are supplied with the second potential. In consideration of waveform rounding when an external signal from the signal input terminal 4 is inputted to the RAM 31, relay primitive cells 9, 10 and 11 are arranged in the chip arrangement region 5. The primitive cells 9, 10 and 11 are supplied with the first potential.

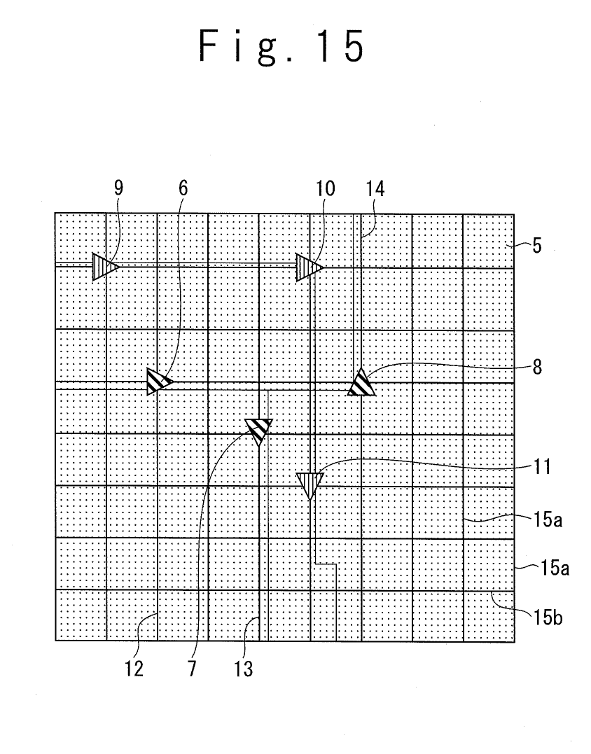

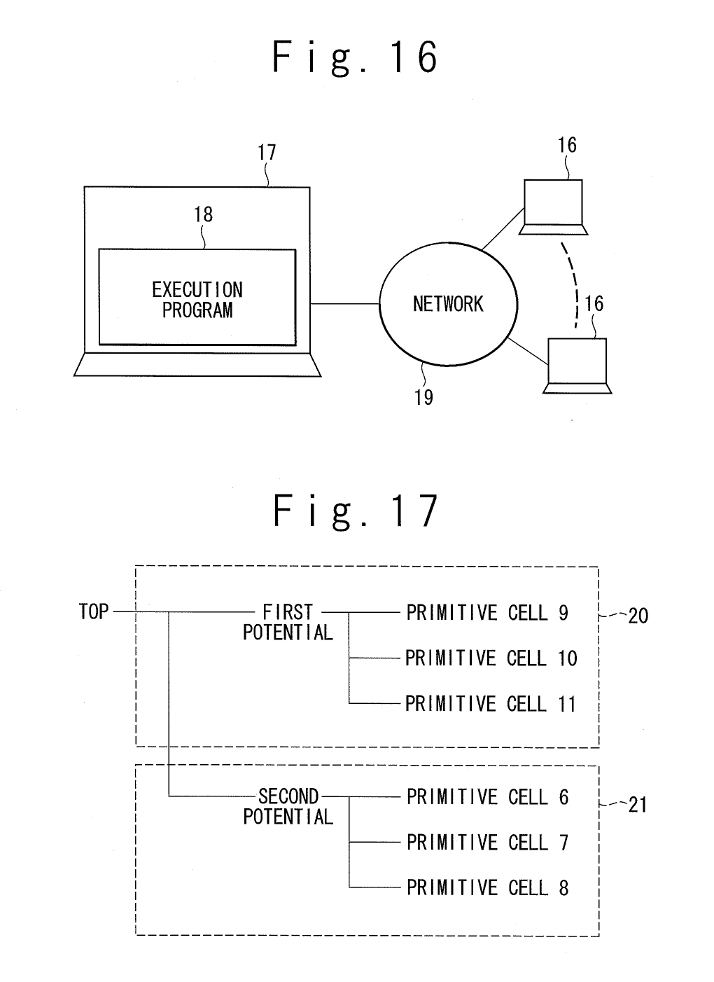

FIG. 15 shows details of the power supply separation shown in the schematic diagram of FIG. 14. In the chip arrangement region 5 supplied with the first potential, the primitive cells 9, 10 and 11 supplied with the first potential are arranged. The primitive cells 6, 7 and 8 supplied with the second potential undergo the power supply separation, and are arranged in the chip arrangement region 5. The primitive cells 9, 10 and 11 are supplied with the first potential from a power supply line in which an upper layer power supply line 15a and a lower layer power supply line 15b are wired in a grid formation. The primitive cells 6, 7 and 8 are supplied with the second potential from power supply lines 12, 13 and 14.

A designer in charge starts to design a layout by downloading the execution program from the server 17 to the computer apparatus 16 shown in FIG. 16. It is to be noted that the entire process steps described in the following are the steps executed by the computer apparatus 16, and that the data or the like inputted or outputted during the process steps are exchanged between the storage medium 18.

Next, in Step S1, portions of a semiconductor integrated circuit driven by a plurality of power supplies are classified by each of power supply systems. For example, as shown in FIG. 17, the portions are classified by each of the power supply systems into a first potential circuit group 20, in which the first potential is the main power supply of the chip, and a second potential circuit group 21. FIG. 17 shows a result of the classification carried out for the semiconductor integrated circuit shown in the schematic diagram of FIG. 14. The semiconductor integrated circuit has two power supply systems respectively having the first potential and the second potential. The primitive cells 9, 10, and 11 belong to the first potential, and the primitive cells 6, 7, and 8 belong to the second potential.

Next, as the floor planning step, a chip size estimation is performed in Step S2, and a hard macro arrangement as to a memory block such as the RAM and functional blocks is carried out in Step S3.

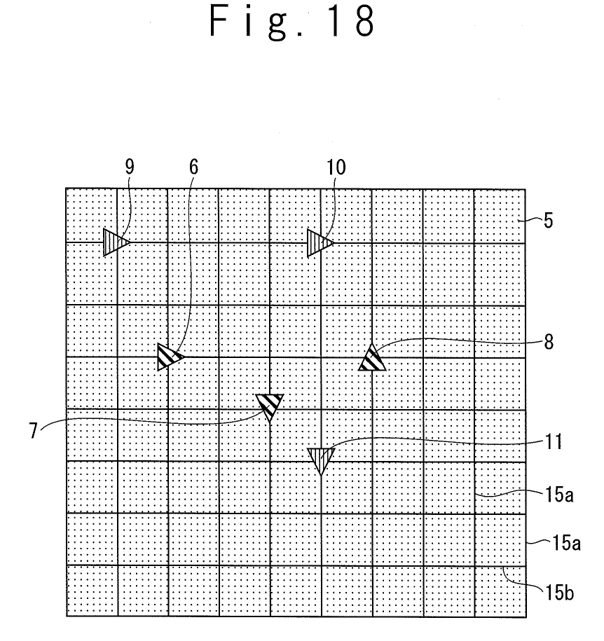

Next, in Step S4, wiring of the power supply lines is carried out, and in Step S5, an arrangement of every primitive cell on the chip is carried out. The execution result of the Steps S4 and S5 is shown in FIG. 18. FIG. 18 shows that, on the power supply lines 15a and 15b wired in Step S4, the primitive cells 6, 7, 8, 9, 10, and 11 arranged in Step S5 are arranged. In Step S4, without separating the first potential circuit group 20 and the second potential circuit group 21 shown in FIG. 17, the power supply lines are arranged on the condition that a single power supply for driving the first potential circuit group 20 solely supplies the power. In Step S5, the primitive cells 6, 7, 8, 9, 10, and 11 are arranged in the arrangement places without being restricted by the type of power supply systems to which they belong.

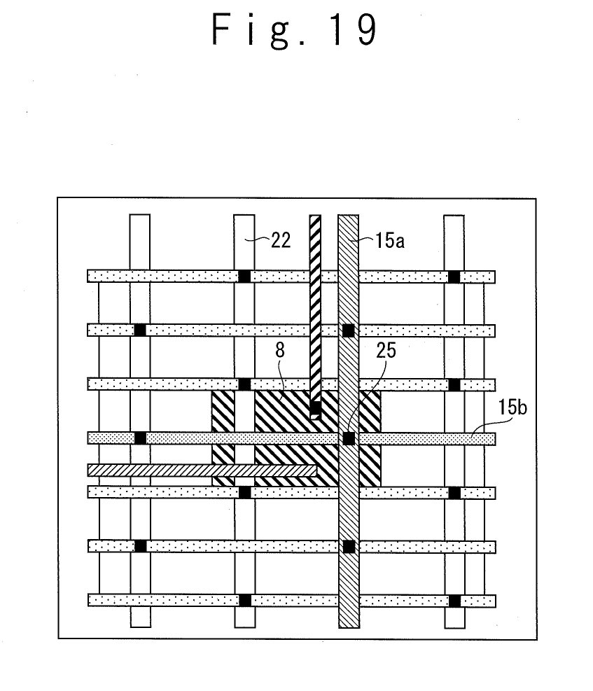

FIG. 19 shows details of the lines supplying power to the primitive cell 8 shown in FIG. 18, which are wired based on the single power supply in Step S4. Though the primitive cell 8 belongs to the second potential circuit group 21 shown in FIG. 17, at this design stage, the primitive cell 8 is wired such that it is supplied with the first potential. Specifically, the first potential is supplied from the power supply line 15a via a through hole 25 and the power supply line 15b to the primitive cell 8. Further, the primitive cell 8 is supplied with a GND potential from a GND supply line 22.

Subsequently, it is checked whether there are no yet-to-be arranged cells on the chip at Step S6. Until the arrangement of all primitive cells is completed, Steps S5 to S6 are repeatedly performed. When the arrangement of all primitive cells is completed, schematic wiring is carried out in Step S7. In Step S8, it is determined that whether or not detailed wiring based on the result of the schematic wiring is possible. When it is determined that such wiring is possible, then the detailed wiring is carried out in Step S9. When such wiring is determined to be impossible, the operation returns to the chip size estimating Step S2, and the chip size is re-adjusted.

Next, in Step S10, a timing check is performed, in which the program determines whether or not the timing of a signal supplied to each primitive cell satisfies a prescribed criterion. When it is determined that there are no problem with the timing, the operation proceeds to Step S11, which is a wiring step for supplying power to a primitive cell that undergoes the power supply separation, such that the cell is supplied with power from its corresponding power supply (hereafter referred to as the “potential changeover”). When it is determined that there is a problem with the timing and therefore re-wiring is required, the operation returns via loop A to Step S7, and the schematic wiring is carried out again. When it is determined that there is a problem with the timing and the program determines that, though a fundamental reconsideration of the chip size is not required, but a circuit modification, or an addition/change of the primitive cell is necessary, the operation returns via loop B to step S5, and a re-arrangement is carried out. When it is determined that there is a problem with the timing, and at the same time it is automatically determined that a fundamental reconsideration of the chip size according to a prescribed procedure described in the program is necessary, the operation returns via loop C to the chip size estimating Step S2, and a re-adjustment of the chip size is carried out.

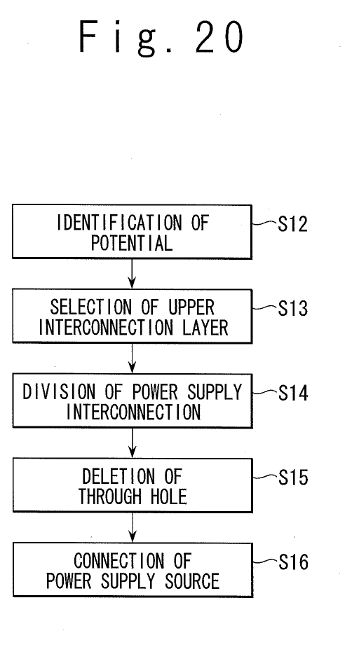

Next, in Step S11, the potential changeover is carried out. FIG. 20 is a detailed flowchart of Step S11 that is the potential changeover step. First, in Step S12, a potential identification is carried out. In Step S12, by referring to a net list that has been inputted in advance, the potential to be supplied after power supply separation is performed to the primitive cell that is to undergo the power supply separation is identified. For example, in FIG. 19, the primitive cell 8 to be supplied with the second potential after the power supply separation is identified.

Next, in Step S13, an upper level connection layer selection is carried out. In Step S12, the power supply lines for supplying power after the power supply separation is performed to the primitive cell that is to undergo the power supply separation is identified. This identification is carried out based on the data indicative of respective arrangement positions of the primitive cell and the power supply lines that is generated in advance before this step. Here, the identification and the selection of the power supply lines are carried out in turn starting from the power supply line of the lowermost layer to the power supply line of the topmost layer for supplying power to the primitive cell that is to undergo the power supply separation. For example, referring to FIG. 19, firstly, the power supply line 15b being the lowermost layer connected to the primitive cell 8 is identified and selected, as the line for supplying power to the primitive cell 8. Then, the power supply line 15a being the topmost layer connected thereto via the through hole 25 is identified and selected. While FIG. 19 shows an exemplary case where the wiring layers are two, the same holds true for multiple layers where the wiring layers are two or more, and the layers are identified and selected in turn from the lowermost layer to the topmost layer in the same manner.

Next, in Step S14, the power supply lines selected in Step S13 are divided. In Step S15, a through hole deletion is carried out so as to avoid short-circuiting between the potentials respectively supplied before and after the power supply separation to the power supply lines divided in step S14.

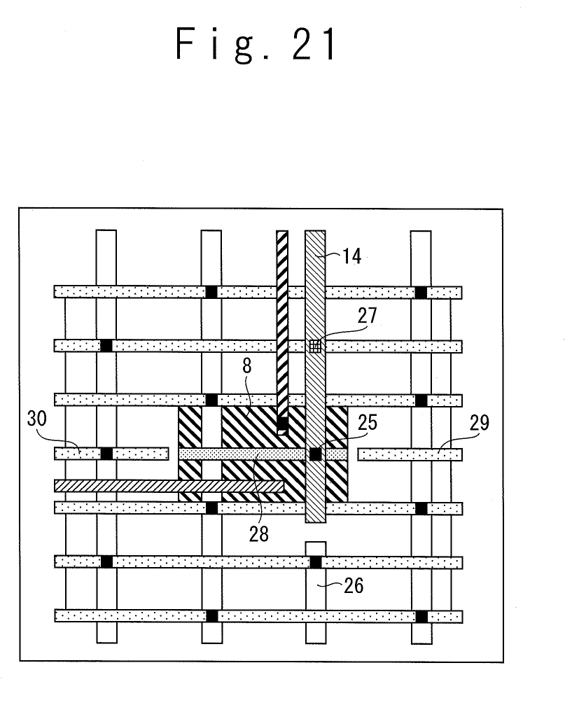

FIG. 21 shows a result of performing the processes of Steps S14 and S15 to the primitive cell 8 shown in FIG. 19. In the drawing, power supply lines 14, 26, 28, and 29 divided in Step S14 and a through hole 27 deleted in Step S15 are shown.

In Step S14, the lowermost layer power supply line 15b shown in FIG. 19 and selected in Step S13 is divided at boundary portions of the primitive cell 8 into the power supply lines 28, 29 and 30. Further, in order to connect one end of the uppermost layer power supply line 15a shown in FIG. 19 to the second potential after power supply separation, the other end side not to be connected to the second potential after the power supply separation is divided at a boundary portion of the primitive cell 8 into the power supply lines 14 and 26.

In Step S15, by deleting the through hole 27 that connects the power supply line 14 divided in Step S14 and the power supply line of the main power supply, the power supply line 14 is electrically separated from the main power supply.

Next, in Step S16, a power supply source connection is carried out. In Step S16, a second power supply that generates the second potential is connected to the power supply line 14 shown in FIG. 21. Thus, the second potential is supplied from the power supply line 14, via the through hole 25 and the power supply line 28, to the primitive cell 8.

By completion of Step S16 as described above, the potential changeover of Step S11 shown in FIG. 13 is completed. This completes the procedure of the power supply separation procedure.

In the layout design method according to the present embodiment, power supply separation is carried out for a semiconductor integrated circuit having a plurality of power supply systems in an internal circuit region. A step of wiring power supply lines based on a single power supply for the internal circuit region (Step S4), a step of arranging every primitive cell and carrying out wiring, a step of checking timing, and, if the timing poses no problems, a step of supplying a primitive cell that differs in power supply system from the power supply, which is the single power supply based on which the wiring has been carried out, with a potential from another power supply (Step S11) are carried out.

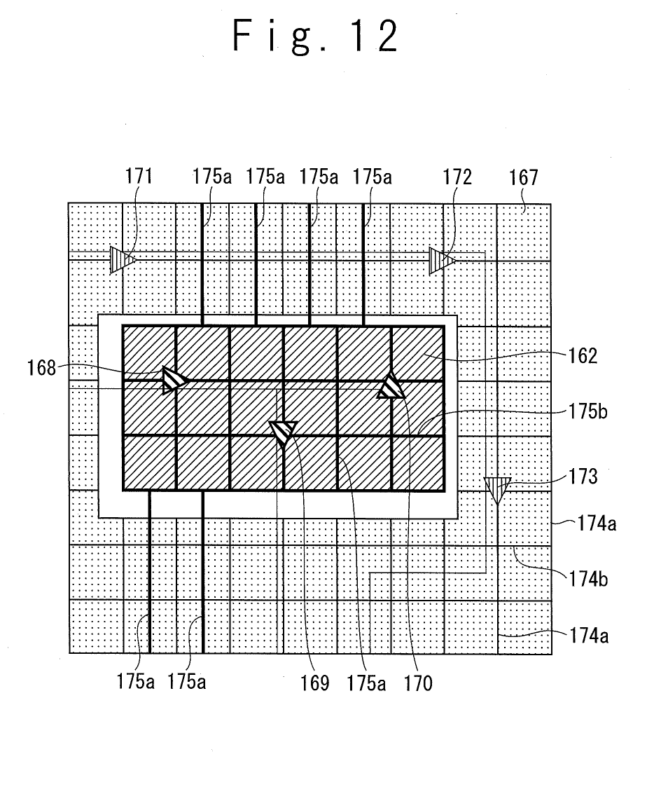

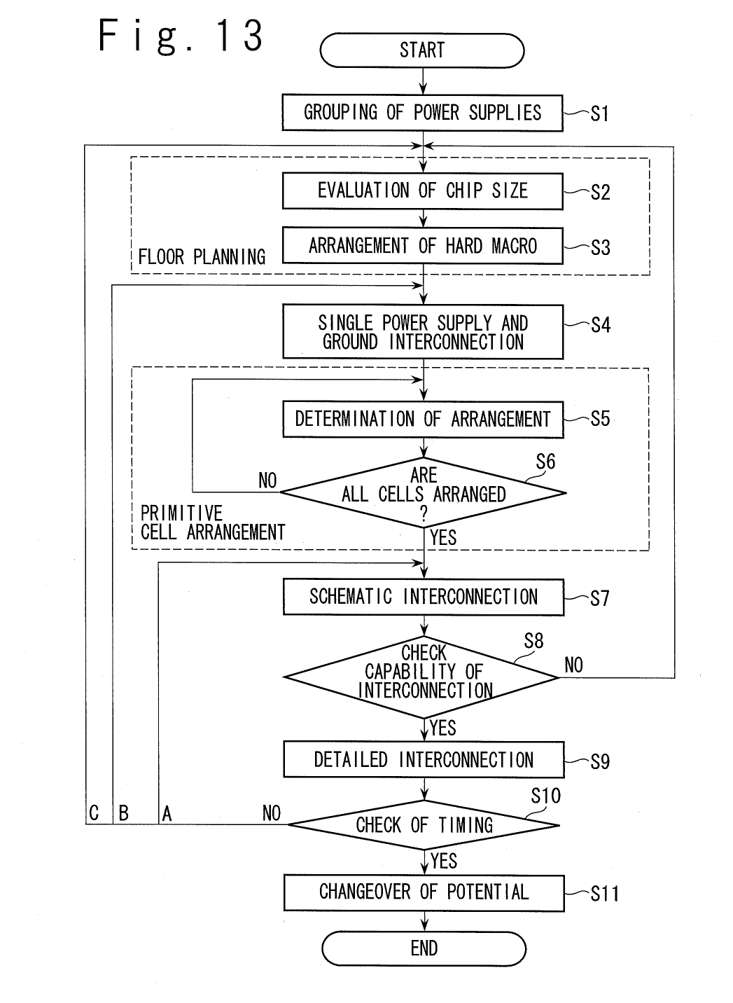

In the steps described above, in Step S4 in which single power supply based power supply/GND wiring is performed, the power supply wiring is carried out by treating a plurality of power supplies as a single power supply. Accordingly, it is not necessary to ensure the arrangement regions of the primitive cells for each power supply system. Further, based on the single power supply, the arrangement of every primitive cell, the wiring, and the timing check are carried out. Until there are no problems exist with the timing, the timing adjustment is repeatedly performed, and thereafter the potential changeover is carried out. The fact that the potential changeover of the primitive cell having undergone the power supply separation is carried out after the timing has checked to make sure that it poses no problems eliminates the necessity, which exists in the technique described referring to FIGS. 11 and 12, for ensuring, for the primitive cell arrangement region that undergoes the power supply separation, an extra region for addressing any additional primitive cell arrangement such as a circuit modification or a timing adjustment that arises following the detailed wiring step. Thus, it becomes possible to solve the problem of an increase in the arrangement region.

A first effect obtained by the present embodiment is a reduction in the chip area. The reason therefor is explained as follows. By carrying out the potential changeover after the primitive cell arrangement, another potential can be supplied only to the primitive cells belonging to the different power supply system. This eliminates necessity for ensuring any primitive cell region for addressing any additional primitive cell arrangement such as a circuit modification or a timing adjustment that arises after the detailed wiring step. Thus, it becomes possible to solve the problem of an increase in the arrangement region associated with the conventional technique.

A second effect is a reduction in the designing period. The reason therefor is explained as follows. By carrying out the potential changeover step after the arrangement and the wiring, the wiring workability is not affected by the power supply separation. Accordingly, a returning to the step of reconsidering the region is not required, which would otherwise necessitated by the region having undergone the potential changeover and resulted in an insufficient area for carrying out the wiring, as in the technique described referring to FIGS. 11 and 12.

A third effect is a faster speed as compared to some conventional techniques. The reason therefor is explained as follows. By carrying out the single power supply based power supply/GND wiring step (Step S4) and the potential changeover step (Step S11), the necessity for ensuring the primitive cell region belonging to the circuit group of different power supply system is eliminated. This eliminates the necessity for arranging the primitive cell belonging to the circuit group supplied with the main power supply of the chip so as to detour the primitive cell region that differs in power system. As a result, a delay between the primitive cells can be shortened.

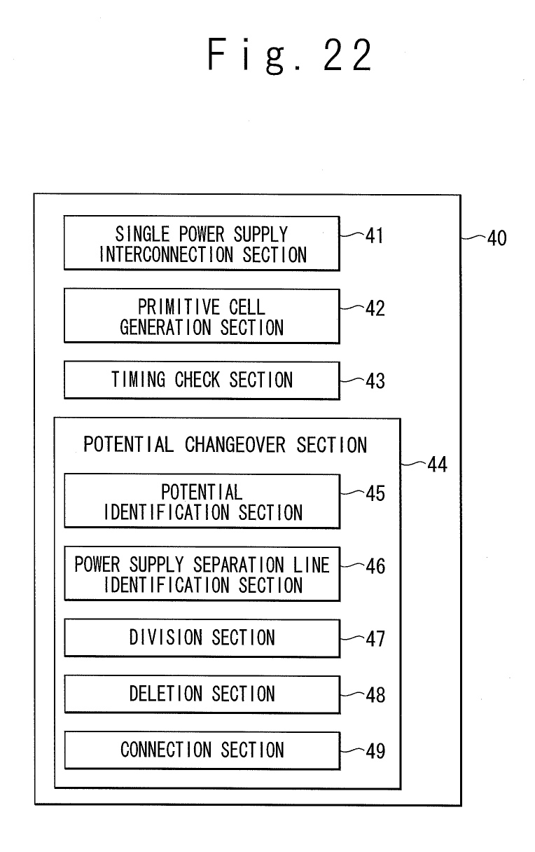

FIG. 22 shows a layout design apparatus for carrying out the layout design method according to the present embodiment. A layout design apparatus 40 includes a single power supply wiring section 41, a primitive cell generation section 42, a timing check section 43, and a potential changeover section 44. These sections are functional blocks realized by a CPU of a computer such as a personal computer reading a program stored in a storage apparatus, and executing data processing in accordance with the description of the program.

The single power supply wiring section 41 carries out the single power supply based wiring of Step S4 in FIG. 13, based on a net list that has been inputted in advance. The primitive cell generation section 42 carries out the operations of Steps S5 to S9, thereby carrying out the arrangement of the primitive cells and the wiring such that the primitive cells are connected to power supply lines of a single power supply. The timing check section 43 carries out the operation of Step S10 to thereby check the timing. The potential changeover section 44 executes the potential changeover operation of Step S11.

The potential changeover section 44 includes a potential identification section 45, a power supply separation line identification section 46, a division section 47, a deletion section 48, and a connection section 49. The potential identification section 45 carries out the potential identifying operation of Step S12. The power supply separation line identification section 46 identifies a power supply line to be used after power supply separation is carried out to a cell for supplying the cell with the second potential, out of wiring lines generated by the single power supply wiring section 41, to thereby carry out the upper level connection layer selection of Step S13. The division section 47 carries out the operation of dividing the power supply line of Step S14. The deletion section 48 deletes, after the dividing operation, any through hole that supplies the potential except for the second potential, such as the first potential generated by the main power supply, to each cell having undergone the power supply separation, to thereby carry out the operation of Step S15. The connection section 49 carries out the operation of Step S16. By the operations described above, the layout design apparatus can execute the layout design method according to the present embodiment.

Although the present invention has been described above in connection with several exemplary embodiments thereof, it would be apparent to those skilled in the art that those exemplary embodiments are provided solely for illustrating the present invention, and should not be relied upon to construe the appended claims in a limiting sense.

What is claimed is:

1. A layout design method comprising:
generating a power supply line of a first power supply in a layout of an internal circuit region;
generating an arrangement of each of a plurality of primitive cells to connect to the power supply line;
checking whether or not a timing of a signal supplied to each of the plurality of primitive cells from the power supply line of the first power supply satisfies a prescribed criterion; and
generating a line for supplying a second potential generated by a second power supply to replace a first potential generated by the first power supply for at least one power supply separation object cell being at least one of the plurality of primitive cells after it is checked that the prescribed criterion is satisfied.

2. The layout design method according to claim 1, wherein the generating the line for supplying the second potential comprises:
identifying a potential which is supplied to each of the at least one power supply separation object cell;
identifying a power supply separation power supply line configured to supply the second potential to each of the at least one power supply separation object cell among the power supply line of the first power supply which is generated at the generating the power supply line of the first power supply;
dividing the power supply separation power supply line between the first power supply and each of the at least one power supply separation object cell;
deleting a through hole configured to supply a potential different from the second potential to each of the at least one power supply separation object cell after the dividing; and
connection the second power supply to the power supply separation power supply line.

3. A computer program product embodied on a computer-readable medium and comprising code that, when executed, causes a computer to perform the following:
generating a power supply line of a first power supply in a layout of an internal circuit region;
generating an arrangement of each of a plurality of primitive cells to connect to the power supply line;
checking whether or not a timing of a signal supplied to each of the plurality of primitive cells from the power supply line of the first power supply satisfies a prescribed criterion; and
generating a line for supplying a second potential generated by a second power supply to replace a first potential generated by the first power supply for at least one power supply separation object cell being at least one of the plurality of primitive cells after it is checked that the prescribed criterion is satisfied.

4. A computer program product according to claim 3 further comprising code that, when executed, causes the computer to perform the following:
identifying a potential which is supplied to each of the at least one power supply separation object cell;
identifying a power supply separation power supply line configured to supply the second potential to each of the at least one power supply separation object cell among the power supply line of the first power supply which is generated at the generating the power supply line of the first power supply;
dividing the power supply separation power supply line between the first power supply and each of the at least one power supply separation object cell;
deleting a through hole configured to supply a potential different from the second potential to each of the at least one power supply separation object cell after the dividing; and
connection the second power supply to the power supply separation power supply line.

5. A layout design apparatus comprising:
a single power supply wiring section configured to generate a power supply line of a first power supply in a layout of an internal circuit region;
a primitive cell generation section configured to generate an arrangement of each of a plurality of primitive cells to connect to the power supply line;
a timing check section configured to check whether or not a timing of a signal supplied to each of the plurality of primitive cells from the power supply line of the first power supply satisfies a prescribed criterion; and
a potential changeover section configured to generate generating a line for supplying a second potential generated by a second power supply to replace a first potential generated by the first power supply for at least one power supply separation object cell being at least one of the plurality of primitive cells after it is checked that the prescribed criterion is satisfied.

6. The layout design apparatus according to claim 5, wherein the potential changeover section comprises:
a potential identification section configured to identify a potential which is supplied to each of the at least one power supply separation object cell;
a power supply separation power supply line identification section configured to identify a power supply separation power supply line configured to supply the second potential to each of the at least one power supply separation object cell among the power supply line of the first power supply which is generated at the generating the power supply line of the first power supply;
a division section configured to divide the power supply separation power supply line between the first power supply and each of the at least one power supply separation object cell;
deletion section configured to delete a through hole configured to supply a potential different from the second potential to each of the at least one power supply separation object cell after the dividing; and
a connection section configured to connect the second power supply to the power supply separation power supply line.
